(19) United States
(12) Patent Application Publication
(10) Pub. No.: US 2025/0282592 A1
(43) Pub. Date: Sep. 11, 2025

(54) AUTOMATED MATERIAL HANDLING HORN SYSTEM AND METHOD

(71) Applicant: Toyota Material Handling, Inc., Columbus, IN (US)

(72) Inventors: Joshua G. Linnemann, Columbus, IN (US); Mustafa Parlaktuna, Indianapolis, IN (US)

(21) Appl. No.: 19/074,674

(22) Filed: Mar. 10, 2025

Related U.S. Application Data
(60) Provisional application No. 63/563,138, filed on Mar. 8, 2024.

(51) Int. Cl. B66F 9/075; B60W 50/14; B60W 50/16; G06V 10/82

(52) U.S. Cl. CPC B66F 9/0755; B60W 50/16; G06V 10/82; B60W 2050/143; B60W 2050/146; B60W 2300/121; B60W 2520/10; B60W 2554/20; B60W 2554/80; G06V 2201/07

(57) ABSTRACT

An automatic horn system and method for a material handling vehicle is provided. An example system includes a perception system and a feedback device. The perception system may be of a material handling vehicle and may include at least one processor and one or more front facing sensors and one or more rear facing sensors designed to capture sensor data of an environment surrounding the material handling vehicle, wherein the at least one processor is designed to identify at least one feature from the sensor data. The feedback device may be of the material handling vehicle and may be designed to perform a feedback operation based at least in part on one or more signals from the perception system.

### CROSS-REFERENCE TO RELATED APPLICATIONS

This Application claims priority to U.S. Provisional Patent Application Ser. No. 63/563,138, filed on Mar. 8, 2024, entitled “AUTOMATED MATERIAL HANDLING HORN SYSTEM AND METHOD,” the entire disclosure of which is incorporated herein by reference.

### BRIEF SUMMARY

This disclosure generally relates to material handling vehicles. More specifically, this disclosure relates to material-handling vehicles equipped with an automated material handling horn system.

### BACKGROUND

Conventional material handling vehicles, like forklifts, should operate in accordance with safety guidelines and regulations in a warehouse or facility. For example, the Occupational Safety and Health Administration (OSHA) under the U.S. Department of Labor sets and enforces safety standards to ensure safe working conditions. Example safety guidelines under OSHA, such as 1910.178(n)(4), requires a driver to slow down and sound the horn at cross aisles and other locations where vision is obstructed. Currently, conventional systems require an operator to manually sound the horn when at cross aisles or other locations.

### SUMMARY

A perception system and a feedback device of a material handling vehicle are provided. The perception system includes at least one processor, one or more front facing sensors, and one or more rear facing sensors designed to capture sensor data of an environment surrounding the material handling vehicle. The at least one processor is designed to identify at least one feature from the sensor data. The feedback device is designed to perform a feedback operation based at least in part on one or more signals from the perception system.

In some aspects, a material handling vehicle may include a perception system and a vehicle controller. The perception system may include a plurality of sensors, wherein each sensor of the plurality of sensors is designed to capture sensor data associated with an environment of the material handling vehicle. The perception system may further include at least one processor in communication with the plurality of sensors, wherein the at least one processor is designed to identify at least one target in the environment of the material handling vehicle based at least in part on the sensor data. The vehicle controller is in communication with the perception system, wherein the vehicle controller is designed to initiate a response based at least in part on the at least one target identified in the environment surrounding the material handling vehicle.

A method for operating a material handling vehicle is also provided. The method may include capturing sensor data via at least one sensor of the material handling vehicle and identifying a target from the captured sensor data. The method may also include performing at least one feedback operation by at least one feedback device of the material handling vehicle based at least in part on a type of the target and at least one of a distance metric or a speed metric of the material handling vehicle.

An apparatus for capturing sensor data via at least one sensor of the material handling vehicle is provided. In some aspects, the apparatus may identify a target from the captured sensor data. The apparatus may also include means for performing at least one feedback operation by at least one feedback device of the material handling vehicle based at least in part on a type of the target and at least one of a distance metric or a speed metric of the material handling vehicle.

An example non-transitory computer-readable medium storing code for wireless communications is described. The code may include instructions executable by one or more processors to capture sensor data via at least one sensor of the material handling vehicle and identify a target from the captured sensor data. The code may also include instructions executable by the one or more processors to perform at least one feedback operation by at least one feedback device of the material handling vehicle based at least in part on a type of the target and at least one of a distance metric or a speed metric of the material handling vehicle.

Some examples of the method, systems, apparatus, material handling vehicles, and non-transitory computer-readable medium described herein may further include operations, features, means, or instructions for applying a computer vision model to the sensor data to identify the at least one feature, wherein the sensor data includes still or continuous images, and determining that the at least one feature matches a type of target.

In some examples of the method, systems, apparatus, material handling vehicles, and non-transitory computer-readable medium described herein, the type of target includes a stop sign, a cross aisle, an end of an aisle, or an aisle sign. The feedback operation may include an action to prevent acceleration of the material handling vehicle, activate a service brake of the material handling vehicle, activate a regenerative brake of the material handling vehicle, or combinations thereof. The feedback operation may include outputting an auditory alert, a visual alert, a tactile alert, or combinations thereof.

Some examples of the method, systems, apparatus, material handling vehicles, and non-transitory computer-readable medium described herein may further include operations, features, means, or instructions for applying the computer vision model to the sensor data the at least one processor is further designed to apply one or more artificial intelligence algorithms to the sensor data to identify the at least one feature from the sensor data.

Additional examples of the method, systems, apparatus, material handling vehicles, and non-transitory computer-readable medium described herein may further include operations, features, means, or instructions for determining a distance between the material handling vehicle and the at least one feature and generating the one or more signals when the distance between the material handling vehicle and at least one feature is less than or equal to a threshold distance value.

Additional examples of the method, systems, apparatus, material handling vehicles, and non-transitory computer-readable medium described herein may further include operations, features, means, or instructions for determining a speed of the material handling vehicle, wherein the one or more signals from the perception system is based at least in part on the speed of the material handling vehicle being greater than or equal to a speed threshold.

### BRIEF DESCRIPTION OF DRAWINGS

FIG. 1 is a side elevational view of a material handling vehicle, according to one example;

FIG. 2 illustrates a block diagram of a system associated with the material handling vehicle of FIG. 1, according to one example;

FIG. 3A and FIG. 3B are examples of image being analyzed by the perception system of FIG. 2 using computer vision;

FIG. 4 is a flowchart showing a method for identifying and responding to targets, according to one example; and

FIG. 5 is a flowchart illustrating an example method for performing a feedback operation based on a detected target, according to one example.

### DETAILED DESCRIPTION

Devices on material handling vehicles, such as forklifts and pallet trucks, which can provide alerts to drivers and others nearby are useful for ensuring workplace safety and operational efficiency. These vehicles often operate in environments with limited visibility, high noise levels, and frequent pedestrian traffic, such as warehouses, factories, and construction sites. For example, horns serve as an audible warning system to alert nearby workers and other vehicle operators of potential hazards, reducing the risk of collisions and accidents. By providing a simple yet effective means of communication, horn systems help improve safety in the working environment, provide some protection to personnel, and reduce the chance of damage to goods and equipment.

Material handling vehicles may also be equipped with vision-based systems to aid with enhancing operational safety and efficiency through an advanced perception system. The system may utilize a combination of sensors, processors, and feedback devices to monitor the environment surrounding a material handling vehicle, identify relevant features, and initiate appropriate responses based on the detected features. The perception system may be equipped with front facing and rear facing sensors, such as cameras, to capture environmental data. The perception system may also include at least one processor to analyze the data using computer vision and artificial intelligence algorithms. The perception system may identify targets such as stop signs, cross aisles, aisle ends, and aisle signs, and determine the distance between the material handling vehicle and these targets. The perception system may also include at least one feedback device designed to perform feedback operations such as outputting auditory, visual, or tactile alerts. The perception system may also include a vehicle controller that may perform vehicle control actions like braking or preventing acceleration when instructed by the perception system. The vehicle control feedback operations may be based on a proximity of the material handling vehicle to the target or a speed of the material handling vehicle. The vehicle controller may communicate with the perception system to initiate or deactivate responses depending on the vehicle's speed, heading, and distance to the target.

The disclosure also outlines a method for operating the material handling vehicle, which includes capturing sensor data, identifying targets, and performing feedback operations based on metrics such as distance and speed. The system improves safety and precision by responding to environmental features and adapting to changes in the vehicle's movement or surroundings. This technology may enable material handling vehicles to navigate more safely and efficiently within warehouse and other environments by detecting and responding to environmental features in real time.

The following discussion is presented to enable a person skilled in the art to make and use examples of the disclosure. Various modifications to the illustrated examples will be readily apparent to those skilled in the art, and the generic principles herein can be applied to other examples and applications without departing from examples of the disclosure. Thus, examples of the disclosure are not intended to be limited to examples shown but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of examples of the invention. Skilled artisans will recognize the examples provided herein have many useful alternatives and fall within the scope of examples of the disclosure.

Before any examples are explained in detail, it is to be understood that the disclosure is not limited in its application to the details of construction and the arrangement of components set forth in the following description or illustrated in the attached drawings. The disclosure is capable of other examples and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof, as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

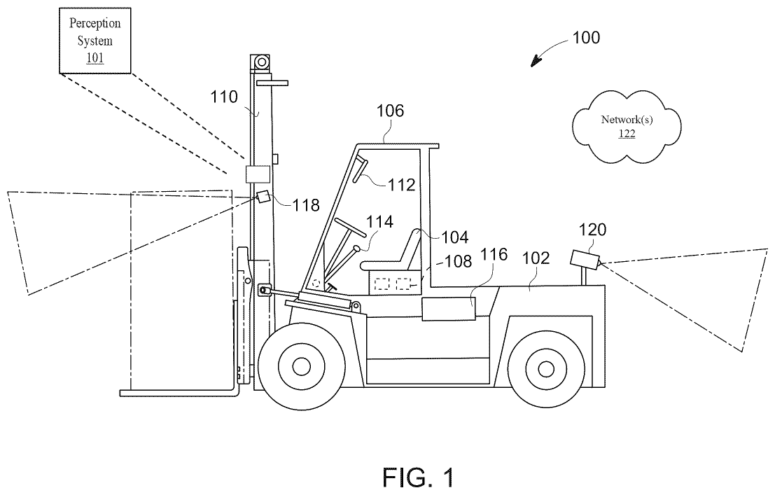

FIG. 1 illustrates a system including a material handling vehicle 100, according to an example. A material handling vehicle 100 may be any type of vehicle that may be capable of transporting materials or equipment, such as a forklift, a counterbalance-type forklift truck, a reach truck, a stacker, a pallet truck, an order picker, or other type of material handling vehicle. The material handling vehicle 100 may include a perception system 101. The material handling vehicle 100 may also be connected to a remote server and/or one or more networks 122. As described herein, the material handling vehicle 100, or any subset of its components, may also be considered a system.

The material handling vehicle 100 may include a body 102, a driver's seat 104, an operator cab 106, a vehicle controller 108, a mast 110, a display module 112, a control module 114, one or more feedback devices 116, one or more front facing sensors 118, and one or more rear facing sensors 120.

In some examples, the material handling vehicle 100 may be operated by a driver who sits in the driver's seat 104. However, in other examples, the material handling vehicle 100 can operate autonomously or via remote control. Examples of the material handling vehicle 100 that are operated remotely or autonomously may not include some of the components or structures described herein, such as the operator cab 106, the driver's seat 104, the control module 114, or the display modules 112.

In the manual driver operation form of the material handling vehicle 100, an operator may use the control module 114 to control the material handling vehicle 100. In some examples, the control module 114 may be provided in the form of one or more control levers. For example, the control module 114 may be used to shift the material handling vehicle 100 between forward or backward motions. The control module 114 may also enable an operator to change gears or a speed of the material handling vehicle 100. The control module 114 may include one or more switches or other control mechanisms to control the operation of the material handling vehicle 100. In other instances, the material handling vehicle 100 may include additional, or fewer, control levers, switches, or instruments which the driver may use to control the material handling vehicle 100 than those described in the example of FIG. 1.

The feedback devices 116 may provide information to an operator of the material handling vehicle 100. The feedback devices 116 may be installed in a number of locations of the material handling vehicle 100, such as near the driver's seat 104, within the operator cab 106, or anywhere else on the body 102, to facilitate notifying the operator or other people proximate to the material handling vehicle 100. The feedback devices 116 may alert the operator, a remote server, or nearby people via auditory, visual, or tactile means provided in the form of sirens, horns, announcements, notifications, alerts, lights, strobes, images, vibrations, deacceleration, pulsations, or combinations thereof. For example, the feedback devices 116 may provide data or other information, such as notifications, to the display module 112 for output. The notifications may be provided in the form of various alarms that alert the operator of the material handling vehicle 100 as to conditions of the surrounding environment. For example, a notification may be sent to a remote server including information about an operator and the time and location that an operator failed to slow down during an intersection, or did not stop for a stop sign. Any of the described data, alerts, images, notifications, or the like described herein may be communicated to the one or more networks 122, including a remote server communicatively coupled to the one or more networks 122.

The one or more front facing sensor 118 and the one or more rear facing sensors 120 may include one or more of a positioning sensor, such as a Global Positioning System (GPS) receiver or a Global Navigation Satellite System (GNSS) receiver, an accelerometer, a gyroscope, a magnetic sensor, a camera, a proximity sensor, a humidity sensor, a pressure sensor, an infrared sensor, a motion detector, a temperature sensor, a microphone, a touch sensor, a level sensor, or other types of sensors.

The perception system 101 may process sensor data to identify one or more targets within the vicinity of the material handling vehicle. The perception system 101 may initiate one or more feedback operations based on detecting the targets and one or more additional factors. Although the perception system 101 is represented near the front facing sensors 118 of the material handling vehicle 100 in FIG. 1, different components of the perception system 101 may be in different places of the material handling vehicle 100. In some examples, some components of the perception system may be located external to the material handling vehicle 100.

The perception system 101 may be capable of wireless or wired communications with the one or more networks 122 over at least one communication link. The perception system 101 described herein may be able to communicate with various types of devices, such as Internet-of-Things (IoT) devices, as well as network entities associated with the one or more networks 122. In some examples, other IoT devices may act as relays for the perception system 101 to provide information to the one or more networks 122 or to other material handling vehicles 100.

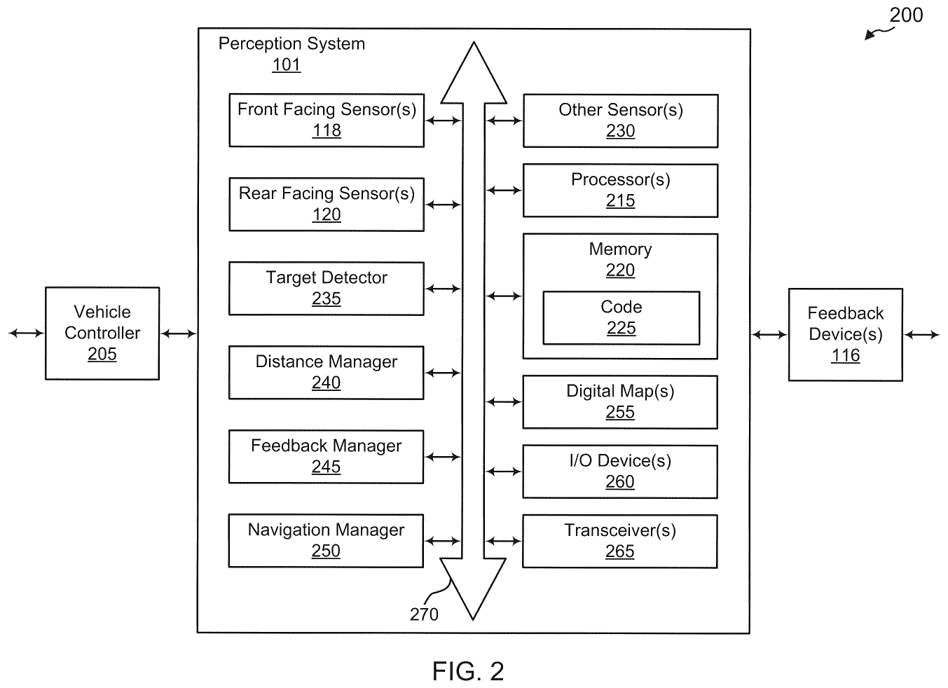

In some example examples, either or both the perception system 101 and the feedback device 116 may be modular. For example, the perception system 101, may be removably connected with one or more components of the material handling vehicle 100. For example, the perception system 101 may be in the form of a module that may support quick connection (e.g., plug and play) to the one or more processors 215 (as shown in FIG. 2) of the material handling vehicle 100. Likewise, the feedback device 116 may be modular. The perception system 101 or the feedback device 116 may be able to be retrofit onto different types of material handling vehicles 100.

The front facing sensor 118 and the rear facing sensor 120 may be provided in the form of one or more cameras, laser scanners, accelerometers, gyro sensors, proximity sensors, radars, lidars, optical sensors (for example, infrared sensors, photoelectric sensors, etc.), acoustic sensors, barometers, thermometers, or other suitable sensors or any combination thereof. The front facing sensor 118 may be positioned to sense the environment in front of the material handling vehicle 100. The front facing sensor 118 may be attached to the mast 110 or to another portion of the front end of the material handling vehicle 100. Similarly, the rear facing sensor 120 may be positioned to sense the environment behind the material handling vehicle 100. The rear facing sensor 120 may be positioned on or adjacent the rear end of the body 102, for example.

The front facing sensor 118 and the rear facing sensor 120 may sense various parameters of the environment surrounding the material handling vehicle 100, such as visual, auditory, or other environmental features. One or more of the front facing sensors 118 or the rear facing sensors 120 may also be configured to generate sensor data. The front facing sensors 118 and the rear facing sensors 120 may communicate the corresponding sensor data with the one or more processors 215 of the perception system 101. For example, the front facing sensor 118 and the rear facing sensor 120 may capture still or continuous images and provide the corresponding image data to the one or more processors 215 for analysis or display.

The one or more networks 122 may connect to the material handling vehicle 100 via at least one communication link. The one or more networks 122 may be provided in the form of, for example, the Internet, intranets, extranets, wide area networks (WANs), local area networks (LANs), wired networks, wireless networks, cloud networks, or other suitable networks, or any combination of two or more such networks. For example, such networks may include cellular networks, satellite networks, cable networks, Wi-Fi networks, Ethernet networks, RS485 connections, and other types of networks. In some instances, the one or more networks 122 may be operating in accordance with a Global System for Mobile Communication (GSM) network, a Code Division Multiple Access (CDMA) network, a Long Term Evolution (LTE) network, an LTE-Advanced (LTE-A) network, an LTE-A Pro network, a New Radio (NR) network, or other systems and radio technologies, including future systems and radio technologies not explicitly mentioned herein. In some instances, the one or more networks 122 may be provided in the form of a short-range network (such as Bluetooth, Near-Field Communication (NFC), etc.). In one example, the one or more networks 122 may be an isolated private network utilizing a private Internet Protocol (IP) address and limiting access to the network. In some examples, the one or more networks 122 may include one or more computing devices that may be arranged, for example, in one or more server banks or computer banks, or other arrangements.

The one or more networks 122 may connect to a cloud-based remote server, which may be a remote processing module communicatively connected to the material handling vehicle 100 using wireless or wired communication protocols. As used herein, the terms “transmitting,” “receiving,” or “communicating,” when referring to the one or more networks 122, may refer to any portion of the one or more networks 122 or a network entity (e.g., a base station, a central unit, a distributed unit, a radio unit, etc.) of a radio access network communicating with another device (e.g., directly or via one or more other network entities).

Although FIG. 1 shows the material handling vehicle 100 as a counterbalance-type forklift truck, other examples of material handling vehicles are contemplated. The material handling vehicle 100 may be provided in the form of any material handling vehicle or other vehicle used to transport materials. For example, the material handling vehicle 100 may be provided in the form of a reach truck, a stacker, a pallet truck, or an order picker, for example. Furthermore, the material handling vehicle 100 may include additional components, actuators, gadgets, appliances, or machines.

In some examples, the material handling vehicle 100 may use one or more artificial intelligence models to perform assessments aspects of the system. In some forms, artificial intelligence may streamline data processing techniques, improve pattern recognition methods, improve controlling the perception system 101 via predicting when to apply adjustments to the camera settings, and assist with fleet manager duties.

FIG. 2 illustrates a system 200 that includes a perception system 101, a vehicle controller 205, and a feedback device 116. The perception system 101, the vehicle controller 205, and the feedback device 116 may be mounted on a vehicle, such as the material handling vehicle 100 of FIG. 1. Some or all of the components of the system 200 may be able to communicate with each other via a wireless or wired connection. In some examples, some of the components of the system 200 may be located external to the material handling vehicle 100. Any components of the system 200 external to the material handling vehicle 100 may communicate with the material handling vehicle 100 and the other components installed on the material handling vehicle 100 via a wireless or wired connection. Some of the components described in the example system 200 may not be included in every example, while other components may be included in other example systems. The perception system 101 may be an example of, or include one or more aspects of, the perception system 101 as described with respect to FIG. 1.

The vehicle controller 205 may be designed to, or otherwise configured to, control various functions of the material handling vehicle 100. For example, the vehicle controller 205 may be able to control acceleration, braking, and steering of the material handling vehicle 100. The vehicle controller 205 may also be able to change the gear the material handling vehicle 100 is operating in, switch between forward and reverse directions, and change the heading of the material handling vehicle 100. The vehicle controller 205 may perform any of these functions in response to receiving instructions from the perception system 101. The instructions may be in the form of one or more signals, for example.

In some examples, an operator of the material handling vehicle 100 may be able to control some of the functionality of the material handling vehicle via the vehicle controller 205. However, in other examples, an operator may not be able to directly interact with the vehicle controller 205.

The perception system 101 may include at least one processor 215, one or more front facing sensors 118, one or more rear facing sensors 120, one or more other sensors, memory 220, computer-executable code 225, a target detector 235, a distance manager 240, a feedback manager 245, a navigation manager 250, digital maps 255, at least one input and output (I/O) device 260, and at least one transceiver 265. These components may be in electronic communication or otherwise connected (e.g., operatively, communicatively, functionally, electronically, electrically) via one or more buses (e.g., a bus 270).

The front facing sensor 118 and the rear facing sensor 120 may be provided in the form of one or more imaging devices, cameras, laser scanners, proximity sensors, radar sensors, lidar sensors, optical sensors (such as infrared sensors), a GPS or GNSS receiver, acoustic sensors, or other suitable sensors or any combination thereof. The other sensors 230 may be provided in any of the forms described above as well as one or more accelerometers, gyro sensors, barometers, thermometers, humidity sensors, microphones, touch sensors, motion detectors, or any other suitable type of sensor.

The front facing sensor 118 may be positioned to sense an environment in front of the material handling vehicle 100. In some examples, the front facing sensor 118 may be attached to the mast 110 or to another portion of the front end of the material handling vehicle 100. The rear facing sensor 120 may be positioned to sense an environment behind the material handling vehicle 100. The rear facing sensor 120 may be positioned on the rear end of the body 102. Although a single sensor is described for each of the front facing sensor 118 and the rear facing sensor 120, both of these may be provided in the form of multiple sensors or sensing devices.

Both the front facing sensor 118 and the rear facing sensor 120 may sense various parameters of the environment surrounding the material handling vehicle 100, such as visual, auditory, or other environmental features, may capture or otherwise generate sensor data. The front facing sensor 118 and the rear facing sensor 120 may communicate the sensor data to the at least one processor 215 or the target detector 235. For example, the front facing sensor 118 and the rear facing sensor 120 may capture still or continuous images and provide the corresponding image data to the at least one processor 215 or the target detector 235 for analysis.

The target detector 235 may receive the captured sensor data from the front facing sensor 118, the rear facing sensor 120, or the other sensors 230, either directly from the sensors or via another component of the perception system 101, such as the at least one processor 215. In some examples, the captured data may be image-based data, such as still images or video. The image-based data may be in the visible spectrum or in other portions of the radio frequency spectrum, such as infrared. The target detector 235 may perform image processing techniques, such as computer vision techniques, on the captured data to identify one or more targets. Example targets may include pedestrians, animals, obstacles, stop signs, other types of traffic signs, cross aisles, ends of aisles, aisle signs, other vehicles, or other features of the environment. Further, the target detector 235, using computer vision techniques, may identify and classify various targets in the environment. The types of targets may include people and animals, traffic signs, other vehicles, merchandise, generic obstacles, or any other type of target.

In some examples, the targets may be predefined. However, in other examples, the target detector 235 may learn to identify certain targets with artificial intelligence or machine learning through a training set of target images. For example, the target detector 235 may be provided with one or more artificial intelligence algorithms, such as computer vision, neural networks, or machine learning algorithms to locate and identify targets within the images captured by the front facing sensor 118 or the rear facing sensor 120. In some examples, specific code, functions, and modules may be configured into the target detector 235 from an open-source library. The target detector 235 may match images in the sensor data to images from the library, and may use information such as size, shape, color, position, location, digital map information, and predictions given environmental clues to detect or identify the targets.

The target detector 235 may output one or more signals indicating that one or more targets have been identified. For each identified target, the output may include information about the target such as a type of target, a timestamp for when the target was detected, identifying information about the target, a size of the target, and the like. The output may be provided to any of the components of the perception system 101, such as the at least one processor 215, the memory 220, the distance manager 240, the feedback manager 245, the navigation manager 250, and the like.

The distance manager 240 may determine a distance between the material handling vehicle 100 and any targets identified by the target detector 235. The distance manager 240 may receive sensor data, such as a GNSS or GPS location, proximity data, image data, or the like from the from the front facing sensor 118, the rear facing sensor 120, or the other sensors 230. The distance manager 240 may receive this data either directly from the sensors or via another component of the perception system 101, such as the at least one processor 215. The distance manager 240 may determine a distance from the material handling vehicle 100 to each of the identified targets based on the sensor data. In some examples, the distance manager 240 may determine the distance using any suitable technique for measuring distance. Such techniques may include using radar, lidar, or sonar information, infrared distances measurements, utilizing a map of the environment, image processing to determine distance to the target, GNSS data, Radio Frequency Identification (RFID) tags, near-field communications, data from proximity sensors, stereo vision techniques, monocular vision with depth estimation, odometry techniques, and the like.

In some examples, the distance manager 240 may receive information about an identified target and measure the distance between the material handling vehicle 100 and the target. The distance may be a real-time distance or may be a predicted distance based on a certain timeframe. For example, the distance may be determined based on a predicted location of the material handling vehicle and the target when a predetermined duration has passed, such as 3 seconds. In other examples, other durations may be used. If there are more than one target, the distance manager 240 may perform the distance measurements for each target.

The distance manager 240 may also apply techniques to determine if the distance may be changing based on motion of the target. For example, if the distance manager 240 determines that the target is moving towards or away from the material handling vehicle 100, the distance manager 240 may adjust the distance based on the determined motion.

In other examples, the distance manager 240 may also determine a speed of the material handling vehicle 100. The distance manager 240 may determine a current speed or a predicted speed in a predetermined timeframe. In some examples, the current speed may be determined based on accelerometer data or any other types of data described herein. The predicted speed may be based on factors, including but not limited to, a history of the operator, an incline or decline of the direction the material handling vehicle 100 is heading, a current acceleration rate, a current deceleration rate, or the like. The distance manager 240 may also determine a relative speed between the material handling vehicle 100 and each target.

The distance manager 240 may output one or more signals indicating one or more of the distance between the material handling vehicle 100 and each target, the predicted distance between the material handling vehicle 100 and each target, the current speed of the material handling vehicle, a predicted speed of the material handling vehicle 100, relative speeds between the material handling vehicle 100 and each target, or combinations thereof. The output may be provided to any of the components of the perception system 101, such as the at least one processor 215, the memory 220, the target detector 235, the feedback manager 245, the navigation manager 250, and the like.

The feedback manager 245 may receive one or more signals regarding the targets, the type of targets, the predicted distance between the material handling vehicle 100 and each target, the current speed of the material handling vehicle, a predicted speed of the material handling vehicle 100, relative speeds between the material handling vehicle 100 and each target, additional information, and combinations thereof. The feedback manager 245 may process the input to determine what, if any, feedback operations may be taken.

For example, the feedback manager 245 may determine that a target is in the line-of-sight of the front facing sensor 118. The target may be an aisle. In this example, the distance manager 240 has determined that the aisle is 5 meters (m) in front of the material handling vehicle 100 and that the material handling vehicle 100 is moving at 3 meters per second (m/s). The feedback manager 245 may compare the distance to a distance threshold. Here, the distance threshold may be 6 m, and the feedback manager 245 may determine a distance metric. The distance metric may be that the target is closer to the material handling vehicle 100 than the distance threshold, for example, 5 m or a negative distance metric (1 m closer). The feedback manager 245 may also determine that the material handling vehicle 100 is moving faster than a speed threshold of 2 m/s, which may be a speed metric of 1 m/s or a positive speed metric (1 m/s faster). Based on any of the identified target, the type of target, the distance, the distance metric, the speed, the speed metric, or combinations thereof, the feedback manager 245 may determine that a feedback operation should be performed. The feedback manager 245 may determine the type of feedback operation based on any of the foregoing parameters, such as the target, the type of target, the distance, the distance metric, the speed, the speed metric, characteristics of the operator, or other suitable factors.

The feedback manager 245 may output one or more signals to activate at least one feedback device 116, generate a notification, or instruct the vehicle controller 205 to control the movement of the material handling vehicle 100. The one or more signals may be based on the analysis performed by the target detector 235, the distance manager 240, and the feedback manager 245. The one or more signals may include instructions to activate a feedback device 116 and/or generate a notification. Additionally, or alternatively, the one or more signals may include instructions to the vehicle controller 205 to control the material handling vehicle 100.

The at least one feedback device 116 may receive instructions from the feedback manager 245 to activate the feedback device 116. The feedback device 116 may then perform the feedback operation suitable for the feedback device 116, such as sounding an alarm such as a horn, flashing lights, turning on a siren, turning on strobe lights, turning on other types of lights, providing haptic feedback, or performing other auditory, visual, tactile, or other sensory notifications. The feedback operation may be a notification provided in the form of various alarms that alert the operator of the material handling vehicle 100 or others proximate to the material handling vehicle 100 as to the conditions of the surrounding environment. The feedback operation may be generating a notification to transmit to a remote server or user device alerting a supervisor that the operator of the material handling vehicle 100 failed to slow down for an intersection or did not stop at a stop sign, for example. The feedback devices 116 may be configured to alert the operator by auditory, visual, and/or tactile means including, but not limited to, sirens, horns, announcements, lights, light beams, flashing lights, strobes, images, vibrations, haptics, deacceleration, and/or pulsations. The above list of feedback means is in no way meant to be exhaustive.

In some examples, the one or more feedback devices 116 can be provided in the form of a standard vehicle horn. According to techniques described herein, the feedback device 116 may automatically sound the horn as the material handling vehicle 100 approaches an intersection detected by the target detector when the material handling vehicle 100 is close enough to the target (in distance or time, for example) as determined by the distance manager 240. Additionally, in some examples, the one or more feedback devices 116 may be activated manually.

Additionally, or alternatively, the vehicle controller 205 may receive instructions from the feedback manager 245 to perform a feedback operation on the material handling vehicle 100. The feedback operation may control the material handling vehicle 100, such as by reducing its speed, increasing its speed, steering the vehicle, changing the heading, changing an operating gear, stopping the vehicle, or the like.

The feedback manager 245 may determine what feedback operation to have performed based on a number of factors, including whether a regulation requirement needs to be met (such as sounding a horn when approaching an aisle intersection) or whether an accident needs to be avoided (such as slowing the speed of the material handling vehicle 100 when a pedestrian is within a certain distance in the direction of movement of the material handling vehicle 100). Other factors may be considered in determining which feedback operations are to be performed. As described herein, multiple feedback operations may be performed simultaneously or relatively simultaneously.

The navigation manager 250 may also provide additional information to the other components of the perception system 101, as described herein. The navigation manager 250 may use one or more digital maps 255 of the current environment of the material handling vehicle 100 to provide information to the target detector 235 of the distance manager 240. The navigation manager 250 may improve or build out a digital map 255 by placing identified targets, for example stationary targets such as traffic signs, on the digital map 255. The navigation manager 250 may provide information from the digital map 255 to the target detector 235 to aid the target detector 235 in identifying targets. The navigation manager 250 may also provide geofencing information, which may be stored in the digital maps 255, to the other components of the perception system 101.

In some cases, the target detector 235, the distance manager 240, the feedback manager 245, and the navigation manager 250 may be implemented as part of one or more processors, such as the at least one processor 215. For example, the at least one processor 215 may send one or more signals, such as control signals, to activate the at least one feedback device 116 or the vehicle controller 205 based at least in part on analysis performed on the sensor data from the front facing sensor 118 or the rear facing sensor 120. The feedback device 116 may provide notifications in the form of auditory, visual, tactile sensory, or a combination thereof based on the one or more control signals.

The at least one processor 215 may be any type of processor, including a digital signal processor (DSP), a central processing unit (CPU), an application-specific integrated circuit (ASIC), a field-programmable gate array (FPGA) or other programmable logic device (PLD), a microcontroller, discrete gate or transistor logic, discrete hardware components, or any combination thereof configured as or otherwise supporting, individually or collectively, a means for performing the functions described in the present disclosure. In some examples, at least one processor and at least one memory in communication with the at least one processor may be configured to perform one or more of the functions described herein (for example, by one or more processors, individually or collectively, executing instructions stored in the at least one memory). In some examples, the one or more processors may be provided in the form of a single-core processor, a dual-core processor, a quad-core processor, a hexa-core processor, an octa-core processor, a deca-core processor, or any other type of processor. In some examples, the target detector 235, the distance manager 240, the feedback manager 245, and the navigation manager 250, or various components thereof, may be implemented in hardware (for example, in circuitry), which may include at least one processor 215.

The at least one memory 220 may include random access memory (RAM) and read-only memory (ROM). The at least one memory 220 may store computer-readable, computer-executable, or processor-executable code, such as the code 225. The code 225 may include instructions that, when executed by the at least one processor 215, cause the perception system 101 to perform various functions described herein. The code 225 may be stored in a non-transitory computer-readable medium such as system memory or another type of memory. In some cases, the code 225 may not be directly executable by the at least one processor 215 but may cause a computer (e.g., when compiled and executed) to perform functions described herein. In some cases, the at least one memory 220 may include, among other things, a basic I/O system (BIOS) which may control basic hardware or software operation such as the interaction with peripheral components or devices.

In some examples, the at least one processor 215 may include multiple processors and the at least one memory 220 may include multiple memories. One or more of the multiple processors may be coupled with one or more of the multiple memories, which may, individually or collectively, be configured to perform various functions described herein. In some examples, the at least one processor 215 may be a component of a processing system, which may refer to a system (such as a series) of machines, circuitry (including, for example, one or both of processor circuitry (which may include the at least one processor 215) and memory circuitry (which may include the at least one memory 220)), or components, that receives or obtains inputs and processes the inputs to produce, generate, or obtain a set of outputs. The processing system may be configured to perform one or more of the functions described herein. For example, the at least one processor 215 or a processing system including the at least one processor 215 may be configured to, configurable to, or operable to cause the perception system 101 to perform one or more of the functions described herein. Further, as described herein, being “configured to,” being “configurable to,” and being “operable to” may be used interchangeably and may be associated with a capability, when executing code 225 (e.g., processor-executable code) stored in the at least one memory 220 or otherwise, to perform one or more of the functions described herein.

The system 200 may also be in communication with one or more network, such as the networks 122 of FIG. 1. Furthermore, the perception system 101 may be integrated with other systems, such as IoT devices. IoT devices may have sensors, software, and other technologies that allow them to communicate with other devices and systems and may transmit data over the internet or other networks. IoT devices may be programmed to perform certain actions, such as automating tasks or informing users. In some examples, the perception system 101 may be integrated with an off-vehicle pedestrian detection system or a forklift with an IoT system or another material handling vehicle 100 with a perception system 101. In this example, the forklift and/or pedestrian detection system with the IoT device may be able to share information with the perception system 101 and further send commands to the perception system 101 based on an identified target. In some aspects, a forklift with an IoT system may send a warning, alert, or notification of an incident to the perception system 101 of the material handling vehicle 100. In yet other examples, an IoT device on an external vehicle may share information about a stop sign or collision with the perception system 101 of the material handling vehicle 100.

The perception system 101 may further include at least one input or output device 260. The at least one input/output device 260 may represent a device integrated into the perception system 101 or a physical connection or port to an external peripheral device. The at least one input or output device 260 may be an input device such as one or more of a modem, a keyboard, a mouse, a touchscreen, a microphone, a trackball, a joystick, or a similar device. The at least one input or output device 260 may be an output device such as one or more of a display, screen, or monitor, a speaker including headphones, or a similar device. In some examples, an input device and an output device may be a same device.

The processor 215, the front facing sensor 118, the rear facing sensor 120, the vehicle controller 108, and the one or more feedback devices 116 are all communicatively coupled to one another and may exchange information via a wired or wireless configuration. In some examples, the material handling vehicle 100 may include at least one additional processor, separate from the processors 215 of the perception system 101. For example, the vehicle controller 205 may include at least one processor. Likewise, the feedback device 116 may include at least one processor.

In some examples, components or aspects of the perception system 101, the vehicle controller 205, and the feedback device 116 may be modular with respect to the material handling vehicle 100. Accordingly, the front facing sensor 118, the rear facing sensor 120, the one or more feedback devices 116, or a combination thereof may be selectively attached to the material handling vehicle 100, or selectively in communication with the processor 215 of the material handling vehicle 100. In at least this way, the perception system 101 elements thereof, and the feedback device 116 may be retrofitted onto several different types of material handling vehicles.

In some examples, the perception system 101, or elements thereof, such as the cameras used for image detection, may be positioned off-vehicle. In this example, the components of the perception system 101 that are positioned off-vehicle may be able to communicate with internal and/or on-vehicle systems.

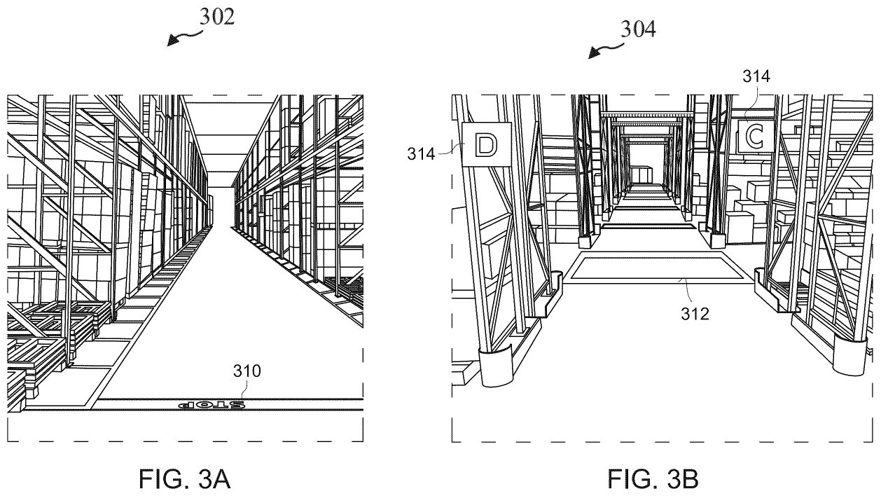

FIGS. 3A and 3B illustrate example images 302 and 304, respectively, captured by a perception system. The images 302 and 304 may be taken using a camera, such as one of the one or more front facing sensor 118 or rear facing sensor 120 of a perception system, such as the perception system 101 of FIGS. 1 and 2. The perception system 101 may be mounted on a material handling vehicle, such as the material handling vehicle 100 of FIG. 1. The perception system may be an example of, or be one or more aspects of, the perception system 101 described with respect to FIGS. 1 and 2. In some examples, the images 302 and 304 may be stills from a video. In these examples, the material handling vehicle may be driven by an operator within a warehouse. In other examples, the material handling vehicle may be operated in other locations, such as a storeroom, a factory, a sort yard, outside, or the like.

FIG. 3A provides an example image 302 that may be captured by a front facing sensor, such as a front facing camera, installed on a material handling vehicle operating within a warehouse. The perception system 101 may identify specific targets within the image 302. For instance, image 302 illustrates the visual field in front of a material handling vehicle, where the word “STOP” has been painted on the floor. The perception system 101, via the target detector, may use image processing techniques to identify, or otherwise detect, the word “STOP” as a target. Specifically, FIG. 3A illustrates the perception system identifying text on a floor at the end of the aisle that is representative of a stop sign.

Further, processor 215 the perception system 101 may determine a type of target for the word “STOP.” In some forms, the perception system 101 may be configured to identify text on an object (e.g., sign, door, etc.), wall, ceiling, or any other surface. A target detector, such as the target detector 235 of FIG. 2, may read the text and provide at least one signal to the feedback manager related to the text.

FIG. 3B is an example of an image captured by the front facing sensor 118 being processed by the processor 215 using computer vision to identify and classify targets at the intersection between two warehouse aisles. Here, an intersection between two warehouse aisles, e.g., the intersection 312, is itself an identifiable target. In addition, FIG. 3B illustrates the processor 215 identifying one or more warehouse aisle signs 314 associated with racks or other physical structure(s). In addition to identifying various targets, the processor 215, using computer vision or other artificial intelligence and machine learning algorithms, can determine one or more of the distance of the material handling vehicle 100 to the identified target, the speed at which the material handling vehicle 100 is approaching the identified target, and the direction that the material handling vehicle 100 is heading with respect to the target. The speedometer data, GNSS data, or other sensor data can also be used to assist the processor 215 in the determination of the distance, speed, and heading of the material handling vehicle 100 with respect to the identified targets.

In some examples, the perception system 101 may use deep learning to identify specific targets. Deep learning may be a type of machine learning that uses artificial neural networks to teach computers to learn and make decisions. In this example, the perception system 101 may learn from unstructured data, like the visuals in a manufacturing warehouse, without needing to be labeled, to perform tasks like image recognition.

In some aspects, one or more digital maps, geofence zones, and/or GPS systems may be uploaded to the perception system 101. In other aspects, environmental features may be added by users of the material handling vehicle 100. In these examples, the material handling vehicle 100 may be able to activate the feedback device 116 based on environmental features on the uploaded digital maps and/or geofence zones. In some examples, the perception system 101 may be able to activate the feedback device regardless of whether an environmental feature is visible to an operator. For instance, the perception system 101 may be able to activate the feedback device 116 for a stop sign that has been removed from its location, has tree branches obstructing its visibility, and/or is not visible to an operator for other reasons based on user input, uploaded digital maps, GPS systems, and uploaded geofence zones.

In some examples, the one or more digital maps, geofence zones, and/or GPS systems may be accessible for a user to edit. In this example, users may access the one or more digital maps, geofence zones, and/or GPS systems to update them with new environmental features such as stop signs, pedestrian crosswalks, intersections, charging stations, dock doors, and anything visual that may be helpful for other users and or operators of the perception system 101 to know about. In some examples, access to the one or more digital maps, geofence zones, and/or GPS systems may include different permission levels based on the status of the user. For example, an operator, dealer, and administrator may have different access to the one or more digital maps, geofence zones, and/or GPS systems. In some examples, an operator may have permission to add a new stop sign to a digital map but may not have permission to remove a stop sign that is no longer present from a digital map. In some forms, an administrator may have permission to remove environmental features from a digital map and/or update geofence zones.

In some examples, the perception system 101 may monitor and/or track an operator's behavior. For example, if an operator of a material handling vehicle 100 is approaching an environmental feature such as an intersection or a stop sign and fails to decrease the speed and/or stop their material handling vehicle 100, the perception system 101 may send a signal to the processor 215 to flag that incident as negative operator behavior. In some examples, the flagged negative operator behavior may be shared with an administrator to notify them of the operator's behavior. In some aspects, the negative operator behavior may be shared via a notification transmitted to a remote server. In some examples, if the perception system 101 senses the operator of its material handling vehicle 100 approaching an environmental feature such as an intersection 312 or a stop sign 310 but does not sense the operator slowing down or decreasing the speed of the material handling vehicle 100, the perception system 101 may send a signal to the feedback device 116 to decrease the speed of the material handling vehicle 100, stop the material handling vehicle 100, or send a log message to the operator of the material handling vehicle 100.

In some aspects, the perception system 101 may use historical data to identify environmental features. For example, if a stop sign has been reported by multiple operators at a specific intersection 312, and multiple operators stop at this specific intersection 312, the perception system may send a signal to the processor 215 to add a stop sign to the intersection 312. In some examples, the reverse may also occur. If the perception system 101 senses a stop sign 310 at a specific intersection 312, but multiple operators continuously drive through the alleged stop sign, the accuracy percentage of the environmental feature may decrease and may prompt the perception system 101 to send a signal to the processor 215 to notify an administrative level user and/or operator to verify and remove it from the digital map.

In some forms, the perception system 101 may use landmark information to override real-time localization. In these examples, if the environmental features are not detected and/or sensed in the locations where the perception system 101 expects them to be, the perception system 101 may still send a signal to the feedback device 116 based on the existing landmark information. In some examples, the perception system 101 may also send the mismatched information to a server or network for correcting the landmark information (e.g., something about the warehouse configuration has been altered and should be updated).

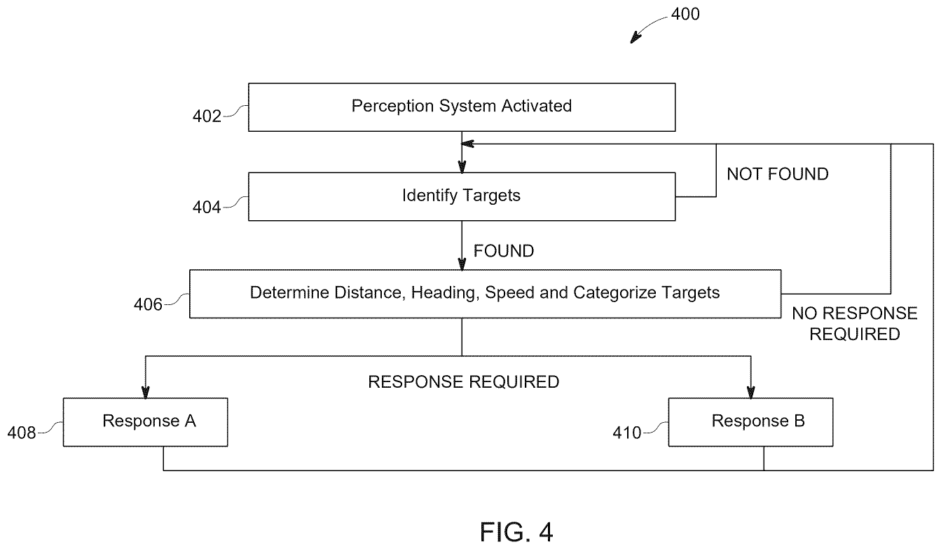

FIG. 4 is a flowchart showing an example method 400 for identifying and responding to targets according to one example. The method 400 may be performed by a perception system, such as a perception system 101 of FIGS. 1, 2, and 4. The camera may be an example of or include one or more aspects of a camera or sensor as described herein, such as a front facing sensors 118 and rear facing sensors 120 of FIGS. 1 and 2. The camera may be part of the perception system 101, which may be located on a material handling vehicle, such as a material handling vehicle 100 of FIG. 1. Some of the techniques described in the example method 400 may not be included in every example, while other techniques may be included in other example methods. Additionally, the techniques may be performed in different orders than that described in method 400.

In addition to the target identification capabilities described above, the processor 215 may also be configured to trigger various responses in the material handling vehicle 100, such as the activation of the feedback device 116 or the control of vehicle movement via braking or acceleration through communication with the vehicle controller 108.

At 402, the perception system 101 may be activated. When activated, the front facing sensor 118 and the rear facing sensor 120 may actively collect data, such as images, and transmit, or otherwise output, the data to the processor 215.

At 404, the perception system 101 may identify one or more targets from the image data using computer vision as described above with respect to FIGS. 3A and 3B. If no targets are identified, the perception system 101 may continue to process image data from the front facing sensor 118 or the rear facing sensor 120 to identify other targets. If one or more targets are identified, such as the stop sign 310, the warehouse aisle sign 314, or the intersection 312, the perception system 101 may determine additional information at 406. Examples of additional information may include one or more of the speeds of the material handling vehicle 100, a distance value from the material handling vehicle 100 to the identified target, a heading of the material handling vehicle 100 with respect to the identified target, or combinations thereof.

Based at least in part on one or more of the types of targets identified, the speed of the material handling vehicle 100, the distance of the material handling vehicle 100 to the target, or the direction the material handling vehicle 100 is moving with respect to the identified target, the at least one processor 215 may activate one or more vehicle responses. The at least one processor 215 may output one or more signals to one or more of the feedback devices 116 or the vehicle controller 108 to perform one or more vehicle responses. The vehicle responses may be factory set, preprogrammed, and/or selectable through vehicle tuning or user selection via a user interface, such as via the display module 112.

In some examples, the user may selectively associate certain targets with one or more vehicle responses. For instance, the user may select or input a particular speed threshold, or a distance threshold associated with one or more vehicle responses. In other examples, the user may associate vehicle heading with one or more vehicle responses. In some forms, the distance threshold may vary depending on the speed at which the material handling vehicle 100 is traveling.

A first response 408, Response A, may include sounding an audible alert from the feedback device 116, such as honking the horn of the material handling vehicle 100 or otherwise providing a sound that simulates honking. A second response 410, Response B, may include altering the movement of the material handling vehicle 100, such as by reducing the maximum allowable vehicle speed, preventing additional acceleration causing the material handling vehicle 100 to coast, activating a service brake of the material handling vehicle 100, activating regenerative braking, or a combination thereof. In another non-limiting example, the first response 408 and/or the second response 410 may include activating other auditory, visual, or tactile feedback via the feedback device 116, such as natural language announcements, lights, strobes, images, vibrations, haptics, etc.

If, on the other hand, the processor 215 determines at 406 that a response should not be activated, the method 400 may return to 404, where the perception system 101 continues processing image data to detect targets. For example, if the type of target identified does not activate a response, if the speed of the material handling vehicle is below a speed threshold, if the distance between the material handling vehicle 100 is above a distance threshold, and/or if the direction of travel of the material handling vehicle 100 renders a response unnecessary, the processor 215 may dismiss the identified target and continue processing image data to identify other targets as the material handling vehicle continues to move. In some aspects, a timer or other software programming may be triggered to prevent repeated identification or consideration of a target that does not activate any vehicle response.

Provided below are a few non-limiting examples of the method 400 in use as the material handling vehicle 100 travels through a warehouse facility. In a first example, the perception system 101 is activated at 402, and the material handling vehicle 100 is approaching the intersection 312 (or the warehouse aisle sign 314) shown in FIG. 3B. The perception system 101 may identify the intersection 312 using computer vision in 404.

Next, the processor 215 may determine the speed of the material handling vehicle 100, the distance of the material handling vehicle 100 to the intersection 312, and the heading of the material handling vehicle 100 with respect to the intersection 312 at 406. If the distance of the material handling vehicle 100 to the intersection 312 is greater than a defined distance threshold for the particular vehicle speed at which the material handling vehicle 100 is traveling, for example, 5 feet (1.5 meters) and 2 miles per hour (mph) (3.2 kilometers per hour (kph)), the processor 215 may determine that no vehicle response should be activated and returns to 404 where the perception system 101 continues to process image data to identify targets. If, on the other hand, the processor 215 determines that the distance of the material handling vehicle 100 to the intersection 312 is equal to or less than a defined distance threshold for the particular vehicle speed at which the material handling vehicle 100 is traveling, the processor 215 may activate the first response 408. In this example, the first response 408 may activate a horn of the material handling vehicle 100.

In some forms, various speed thresholds and/or distance thresholds may be provided. In some examples, each of the thresholds or combination of thresholds may correspond to different vehicle responses. For example, if the processor 215 determines that the distance of the material handling vehicle 100 to the intersection 312 is less than a second defined distance threshold, for example, 3 feet (0.3 meters), and the speed of the material handling vehicle 100 is above a second defined speed threshold, for example 5 mph (8 kph), the processor 215 may activate both the first response 408 and the second response 410. In this example, the processor 215 may activate the horn of the material handling vehicle 100 and also may activate the vehicle service brakes, or regenerative braking, to slow down the material handling vehicle 100. However, despite the identification of a target in 404 and a determination that the thresholds for distance and speed are met for a particular response, if the heading of the material handling vehicle 100 is determined to meet a particular heading condition (e.g., away from the target), the processor 215 may determine that no vehicle response should be activated. In that case, the method 400 may return to 404 where the perception system 101 continues to process image data to identify targets. For example, after the material handling vehicle 100 has crossed the intersection 312 and the material handling vehicle 100 is traveling away from the intersection 312, the response 408 410 will not be re-activated.

In a second non-limiting example, the perception system 101 is activated, and the material handling vehicle 100 is approaching the stop sign 310. At 404, the perception system 101 may identify the stop sign 310 using computer vision. Next, at 406, the processor 215 may determine the speed of the material handling vehicle 100, the distance of the material handling vehicle 100 to the stop sign 310, or the heading of the material handling vehicle 100 with respect to the stop sign 310. If the distance of the material handling vehicle 100 to the intersection 312 is greater than a defined distance threshold for the particular vehicle speed at which the material handling vehicle 100 is traveling, for example, 5 feet (1.5 meters) and 2 mph (3.2 kph), the processor 215 may determine that no vehicle response should be activated. The method 400 may return to 404 where the perception system 101 continues processing image data to identify other targets. If, on the other hand, the processor 215 determines that the distance of the material handling vehicle 100 to the intersection 312 is equal to or less than a defined distance threshold for the particular vehicle speed at which the material handling vehicle 100 is traveling, the processor 215 may activate the first response 408. In this example, the first response 408 activates the vehicle service brakes or regenerative braking to slow the material handling vehicle 100 down as it approaches the stop sign 310.

In some forms, various speed thresholds and/or distance thresholds can be provided, and each of the thresholds, or combination of thresholds, can correspond to different vehicle responses. For example, if the processor 215 determines that the distance of the material handling vehicle 100 to the stop sign 310 is less than the defined distance threshold, for example, 5 feet (1.5 meters), and the speed of the material handling vehicle 100 is above a second defined speed threshold, for example, 5 mph (8 kph), the processor 215 may activate both the first response 408 and the second response 410. In this example, the processor 215 may activate the vehicle service brakes, or regenerative braking, to slow the material handling vehicle 100 down and sound an auditory alert to warn the operator of the upcoming stop sign 310. As the material handling vehicle 100 is traveling away from the intersection 312, the responses 408 and 410 will not be re-activated because of the heading of the material handling vehicle 100 in step 406.

In some forms, one or more of the distance, speed, and heading values with respect to a target can be determined using location data such as location data determined by local warehouse location services or GNSS data. Accordingly, one or more of the responses 408 and 410 can be activated based on whether the material handling vehicle 100 is determined to be approaching one or more targets from the location data. Further, it is to be understood that if multiple targets are identified, multiple distance thresholds are exceeded, and multiple speed thresholds are exceeded, numerous vehicle responses can be activated simultaneously. According to the foregoing disclosure, the method 400 can help ensure that OSHA rules are complied with, for example, by automatically triggering the feedback device 116 (e.g., sounding the horn) at cross aisles identified by the perception system 101 using computer vision.

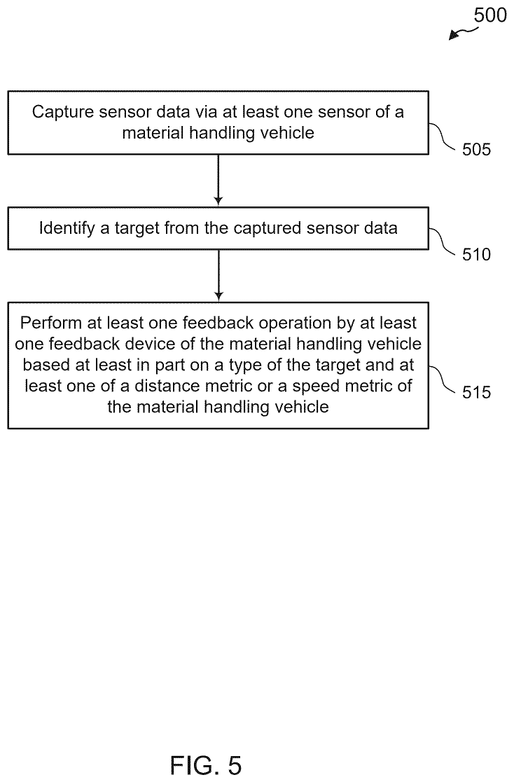

FIG. 5 is a flowchart illustrating an example method 500 for performing a feedback operation based on a detected target, according to various examples. The method 500 may be performed by one or more components of a material handling vehicle. The material handling vehicle may be an example of or may include one or more aspects of the material handling vehicle 100 of FIG. 1. Some aspects of the method 500 may be performed by a perception system, such as the perception system 101 of FIGS. 1 and 2. Other aspects of the method 500 may be performed by a feedback device, such as the feedback device 116 of FIG. 2. In other examples, some aspects of the method 500 may be performed by a vehicle controller, such as the vehicle controller 205 of FIG. 2. Some of the techniques described in the example method 500 may not be included in every example, while other techniques may be included in other example methods. Additionally, the techniques may be performed in different orders than that described in method 500.

At 505, the method 500 may include capturing sensor data via at least one sensor of the material handling vehicle. The at least one sensor may include a front facing sensor or a rear facing sensor. In some examples, the at least one sensor may be a camera. The captured sensor data may be one or more still images or video.

At 510, the method 500 may include identifying a target from the captured sensor data. The method 500 may include performing computer vision techniques on image data to identify the target. In some examples, the target may include stop signs, cross aisles, ends of aisles, aisle signs, or other environmental features of a warehouse, other types of signs, pedestrians, obstacles within the travel path of the material handling vehicle, other vehicles, and the like. In some examples, the method 500 may include analyzing the captured sensor data via at least one computer vision model to distinguish the target from background images. The method 500 may further include comparing an image of the target to a set of images of a plurality of targets to determine the type of target.

At 515, the method 500 may include performing at least one feedback operation by at least one feedback device of the material handling vehicle based at least in part on a type of the target and at least one of a distance metric or a speed metric of the material handling vehicle. In some examples, the feedback operation may include outputting an audible alert, a visual alert, tactile feedback, or combinations thereof. In other examples, the feedback operation may include preventing acceleration of the material handling vehicle, activating a service brake of the material handling vehicle, activating a regenerative brake of the material handling vehicle, activating a different type of brake of the material handling vehicle, changing a heading of the material handling vehicle, increasing the speed of the material handling vehicle, cutting power to the material handling vehicle, or combinations thereof. In some examples, the feedback device 116 may perform the feedback operation. In other examples, the vehicle controller 205 may perform the feedback operation.

In some examples, the method 500 may further include determining a distance between the material handling vehicle and the target. The distance may be determined using any suitable technique for measuring distance, including radar, lidar, sonar, infrared distances measurements, utilizing a map of the environment, image processing to determine distance to the target, GNSS data, RFID tags, near-field communications, data from proximity sensors, stereo vision techniques, monocular vision with depth estimation, odometry techniques, and the like.

In some examples, the method 500 may compare the distance between the material handling vehicle to a threshold distance. In some examples, the distance metric may be associated with the distance between the material handling vehicle and the target being less than or equal to the threshold distance. The distance metric may be associated with the material handling vehicle being closer to the target than the distance threshold. If the material handling vehicle is closer to the target than the threshold distance, the method 500 may perform the feedback operation, such as slowing the material handling vehicle or sounding an alert. For example, if the material handling vehicle is within 5 meters of an intersection, the method 500 may determine that the material handling vehicle is close enough to the intersection that an alert should be issued. Alternatively, if the material handling vehicle is further than the threshold distance, the method 500 may determine that the material handling vehicle is far enough away from the target that a feedback operation is not yet warranted.

In some cases, the threshold distance may be based on a type of target. For example, the method 500 may perform the feedback operation earlier for some types of targets compared with other types of targets. For example, the method 500 may perform the feedback operation, such as sounding a horn, when the material handling vehicle is further away from a pedestrian than when the material handling vehicle is from a sign, such as a stop sign. This may give the pedestrian more time to respond to the oncoming material handling vehicle.

In other examples, the method 500 may determine whether to perform the feedback operation using additional information, such as a speed of the material handling vehicle. For example, the method 500 may include determining the speed of the material handling vehicle. The speed metric is associated with the speed of the material handling vehicle being greater than or equal to a speed threshold. The speed threshold may be set depending upon one or more factors, including the type of environment, the type of material handling vehicle being operated, the presence of pedestrians, local regulations, design of a warehouse or other facility, weather concerns, accident history of the operator, the presence of other vehicles, the presence of a construction zone, the presence of intersections, a number of aisles, spacing between aisles, and the like.

It should be noted that the methods described herein describe possible implementations. The operations and the steps may be rearranged, or otherwise modified and other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by electromagnetic waves, voltages, currents, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by one or more processors, firmware, or any combination thereof. If implemented using software executed by one or more processors, the functions may be stored as or transmitted using one or more instructions or code of a computer-readable medium. Other examples and implementations are within the scope of the disclosure and appended claims. For example, due to the nature of software, functions described herein may be implemented using software executed by one or more processors, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection may be properly termed a computer-readable medium. For example, if the software may be transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that may be described as “based on condition A” may be based on both a condition A and a condition B. For example, as used herein, the phrase “based on” shall be construed in the same manner as the phrase “based at least in part on.”

As used herein, including in the claims, the article “a” before a noun may be open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), identifying, ascertaining, and the like. Also, “determining” can include receiving (for example, receiving information), accessing (for example, accessing data stored in memory), retrieving, and the like. Also, “determining” can include resolving, obtaining, selecting, choosing, establishing, and other such similar actions.

In the appended FIGS., similar components or features may have the same reference label. Further, various components of the same type may be distinguished by following the reference label by a dash and a second label that distinguishes among the similar components. If just the first reference label may be used in the specification, the description may be applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some FIGS., known structures and devices are shown in block diagram form in order to avoid obscuring the concepts of the described examples.

In other instances, other configurations of the systems and methods described herein are possible. For example, those of skill in the art will recognize, according to the principles and concepts disclosed herein, that various combinations, sub-combinations, and substitutions of the components discussed above can provide appropriate control for a variety of different configurations of robotic platforms for a variety of applications.

In other examples, other configurations are possible. For example, those of skill in the art will recognize, according to the principles and concepts disclosed herein, that various combinations, sub-combinations, and substitutions of the components discussed above can provide appropriate control for a variety of different configurations of material handling vehicles, work machines, operator control systems, and so on, for a variety of applications.

The previous description of the disclosed examples is provided to enable any person skilled in the art to make or use the techniques, systems, apparatus, and methods described herein. Various modifications to these examples will be readily apparent to those skilled in the art, and the generic principles defined herein may be applied to other examples without departing from the spirit or scope of the disclosure. Thus, the disclosure is not intended to be limited to the examples shown herein but is to be accorded the widest scope consistent with the principles and novel features disclosed herein.

What is claimed is:

1. A perception system of a material handling vehicle comprising:
at least one processor;
one or more front facing sensors and one or more rear facing sensors designed to capture sensor data of an environment surrounding the material handling vehicle, wherein the at least one processor is designed to identify at least one feature from the sensor data; and
a feedback device of the material handling vehicle, wherein the feedback device is designed to perform a feedback operation based at least in part on one or more signals from the perception system.

2. The perception system of claim 1, wherein to identify the at least one feature from the sensor data the at least one processor is further designed to:
apply a computer vision model to the sensor data to identify the at least one feature, wherein the sensor data includes still or continuous images; and
determine that the at least one feature matches a type of target.

3. The perception system of claim 2, wherein the type of target includes a stop sign, a cross aisle, an end of an aisle, or an aisle sign.

4. The perception system of claim 2, wherein to apply the computer vision model to the sensor data the at least one processor is further designed to apply one or more artificial intelligence algorithms to the sensor data to identify the at least one feature from the sensor data.

5. The perception system of claim 1, wherein the perception system is designed to:
determine a distance between the material handling vehicle and the at least one feature; and
generate the one or more signals when the distance between the material handling vehicle and at least one feature is less than or equal to a threshold distance value.

6. The perception system of claim 1, further comprising:
a vehicle controller, wherein the vehicle controller is configured to determine a speed of the material handling vehicle, wherein the one or more signals from the perception system is based at least in part on the speed of the material handling vehicle being greater than or equal to a speed threshold.

7. The perception system of claim 6, wherein the feedback operation includes generating a notification when the speed of the material handling vehicle is greater than or equal to the speed threshold, the notification including information about an operator of the material handling vehicle and information about a type of target identified from the at least one feature from the sensor data.

8. The perception system of claim 1, wherein the feedback operation includes outputting an auditory alert, a visual alert, a tactile alert, or combinations thereof.

9. A material handling vehicle, comprising:
a perception system, comprising:
a plurality of sensors, wherein each sensor of the plurality of sensors is designed to capture sensor data associated with an environment of the material handling vehicle; and
at least one processor in communication with the plurality of sensors, wherein the at least one processor is designed to identify at least one target in the environment of the material handling vehicle based at least in part on the sensor data; and
a vehicle controller in communication with the perception system, wherein the vehicle controller is designed to initiate a response based at least in part on the at least one target identified in the environment surrounding the material handling vehicle.

10. The material handling vehicle of claim 9, wherein the at least one processor is further designed to:
output at least one signal to the vehicle controller to initiate the response based at least in part on the at least one target and further based at least in part on a speed of the material handling vehicle, a heading of the material handling vehicle, a distance of the material handling vehicle to the at least one target, or combinations thereof.

11. The material handling vehicle of claim 9, further comprising:
a feedback device in communication with the vehicle controller, wherein the feedback device is designed to provide an auditory alert, a visual alert, a tactile alert, or a combination thereof based at least in part on the vehicle controller initiating the response.

12. The material handling vehicle of claim 9, wherein the at least one processor is further designed to:
output a deactivation signal to the vehicle controller to deactivate the response based at least in part on a change in a speed of the material handling vehicle, a change in a heading of the material handling vehicle, an increase in a distance of the material handling vehicle to the at least one target, the at least one target no longer being identifiable in the sensor data, or combinations thereof.

13. The material handling vehicle of claim 9, wherein the response includes generating a notification when a speed of the material handling vehicle is greater than or equal to a speed threshold, the notification including information about an operator of the material handling vehicle and information about the at least one target identified.

14. A method for operating a material handling vehicle, comprising:
capturing sensor data via at least one sensor of the material handling vehicle;
identifying a target from the captured sensor data; and
performing at least one feedback operation by at least one feedback device of the material handling vehicle based at least in part on a type of the target and at least one of a distance metric or a speed metric of the material handling vehicle.

15. The method for operating a material handling vehicle of claim 14, further comprising:
determining a distance between the material handling vehicle and the target, wherein the distance metric is associated with the distance between the material handling vehicle and the target being less than or equal to a threshold distance value.

16. The method for operating a material handling vehicle of claim 14, further comprising:
determining a speed of the material handling vehicle, wherein the speed metric is associated with the speed of the material handling vehicle being greater than or equal to a speed threshold.

17. The method for operating a material handling vehicle of claim 14, wherein performing the at least one feedback operation at the at least one feedback device further comprises:
outputting an audible alert, a visual alert, tactile feedback, or combinations thereof.

18. The method for operating a material handling vehicle of claim 14, wherein performing the at least one feedback operation at the at least one feedback device further comprises:
preventing acceleration of the material handling vehicle, activating a service brake of the material handling vehicle, activating a regenerative brake of the material handling vehicle, or combinations thereof.

19. The method for operating a material handling vehicle of claim 14, wherein the type of the target includes stop signs, cross aisles, ends of aisles, aisle signs, or other environmental features of a warehouse.

20. The method for operating a material handling vehicle of claim 14, wherein identifying the target from the captured sensor data further comprises:
analyzing the captured sensor data via at least one computer vision model to distinguish the target from background images, wherein the captured sensor data includes still or continuous images of the captured sensor data; and
comparing an image of the target to a set of images of a plurality of targets to determine the type of target.
